(19) United States
(12) Patent Application Publication
(10) Pub. No.: US 2026/0350675 A1
(43) Pub. Date: Nov. 5, 2026

(54) Metadata Enforcement, Audit Trail Logging, and Compliance Timestamping for Commercial Transactions

(71) Applicant: ADRIAN FARIAS JARAMILLO, JURUPA VALLEY, CA (US)

(72) Inventor: ADRIAN FARIAS JARAMILLO, JURUPA VALLEY, CA (US)

(21) Appl. No.: 19/336,201

(22) Filed: Sep. 22, 2025

Related U.S. Application Data
(63) Continuation of application No. 19/197,894, filed on May 2, 2025.
(60) Provisional application No. 63/786,937, filed on Apr. 10, 2025.
(60) Provisional application No. 63/787,944, filed on Apr. 13, 2025.
(60) Provisional application No. 63/788,834, filed on Apr. 15, 2025.
(60) Provisional application No. 63/791,534, filed on Apr. 20, 2025.
(60) Provisional application No. 63/792,918, filed on Apr. 23, 2025.

(51) Int. Cl. G06Q 30/0601; G06Q 10/083

(52) U.S. Cl. CPC G06Q 30/0611; G06Q 10/083

(57) ABSTRACT

A system for enforcing metadata capture, logging, and timestamping across commercial execution rails. Each transaction includes device, escrow, user, jurisdiction, and license metadata, recorded in immutable audit logs with compliance validation. Unauthorized modification or omission results in execution denial and enforcement flagging.

### CROSS-REFERENCE TO RELATED APPLICATIONS

This application is a continuation of U.S. Utility patent application Ser. No. 19/197,894, filed May 2, 2025, which claims the benefit of the following U.S. Provisional Patent Applications, each of which is incorporated herein by reference in its entirety:
U.S. Provisional Application No. 63/786,937, filed Apr. 10, 2025, titled “System and Method for Buyer-Initiated Marketplace Transactions Across Multiple Industries”
U.S. Provisional Application No. 63/787,944, filed Apr. 13, 2025, titled “Sealed Toolset and Logic Framework for Buyer-Initiated Offer Systems”
U.S. Provisional Application No. 63/788,834, filed Apr. 15, 2025, titled “Toolset Protection for Modular Buyer-Initiated Offer Ecosystem”
U.S. Provisional Application No. 63/791,534, filed Apr. 20, 2025, titled “Modular Toolset Architecture for Multi-Sector Buyer-Initiated Commerce Infrastructure”
U.S. Provisional Application No. 63/792,918, filed Apr. 23, 2025, titled “Lockdown: Final Enforcement Tools for Global Buyer-Initiated Transaction Control”

### FIELD OF THE INVENTION

The present invention relates to metadata governance in sealed commercial execution systems, and more specifically to systems and methods for logging transaction metadata, enforcing audit compliance, and attaching digital timestamps to commercial events.

### BACKGROUND OF THE INVENTION

Existing transactional platforms lack standardized metadata capture, integrity enforcement, or cross-validated audit trails that are bound to execution rails.

Regulatory and legal frameworks require timestamped logs of commercial activity, yet current systems permit fragmentation, alteration, or omission of such records.

There is a need for a metadata-enforced execution system that binds all commercial activity to a tamper-resistant logging structure.

### SUMMARY OF THE INVENTION

The invention introduces a metadata logging and enforcement rail for commercial execution platforms.

All platform-triggered commercial activity is tagged with structured metadata, including device ID, user session, location, offer path, vendor ID, escrow ID, jurisdiction ID, and compliance signature.

Metadata is stored in immutable audit logs that are cross-referenced across platform services, tools, and jurisdictions.

A digital timestamp is applied to each execution event, forming the basis for compliance certification and dispute resolution.

Any modification attempt to metadata or fulfillment bypass is automatically flagged, rejected, and logged.

### DETAILED DESCRIPTION OF THE INVENTION

The system comprises a metadata capture module embedded in each tool and transaction trigger.

Metadata includes buyer identity, seller identity, tool origin, escrow signature, platform ID, and jurisdiction filter used.

Each execution event is assigned a global transaction ID.

Timestamps are generated by a platform-synced, tamper-proof time engine.

Metadata is written to an immutable database with access permissions tied to compliance role.

Third-party plugins or tools must also capture and report metadata through standardized APIs or be denied execution rights.

If metadata is missing, incorrect, or altered, the transaction is halted.

The audit log allows retrospective enforcement of license violations, fraud events, or platform breaches.

A metadata enforcement layer validates trust tiers, jurisdiction filters, and user role eligibility before allowing downstream execution.

Blockchain or distributed ledger versions of metadata logs may be optionally maintained for external regulator visibility.

What is claimed is:

1. A commercial execution system comprising:
a metadata capture engine;
a compliance enforcement module;
and an audit trail generator that records metadata for each transaction event.

2. The system of claim 1, wherein metadata includes user ID, tool origin, escrow signature, platform license, and timestamp.

3. The system of claim 1, wherein audit trail logs are immutable and cryptographically secured.

4. A method comprising:
receiving a transaction trigger;
capturing associated metadata;
validating compliance status;
and recording the transaction in an audit log.

5. The system of claim 1, wherein metadata entries are rejected if incomplete or unverifiable.

6. The method of claim 4, wherein each transaction is assigned a global transaction ID and timestamp.

7. The system of claim 1, wherein fulfillment is blocked unless metadata meets jurisdictional and platform criteria.

8. The method of claim 4, further comprising: syncing timestamps to a tamper-resistant platform clock.

9. The system of claim 1, wherein metadata enforcement policies are dynamically adjustable based on regulatory requirements.

10. A metadata enforcement engine comprising:
compliance policy logic, jurisdiction filter, user trust scoring, and platform execution permissions.

11. The system of claim 1, wherein attempted modification of metadata results in automatic denial and log entry.

12. The method of claim 4, wherein metadata includes location signature and device fingerprint.

13. A system wherein metadata from third-party tools is captured via standardized API and cross-verified before execution.

14. The system of claim 1, wherein all metadata is available for audit by authorized enforcement entities.

15. The method of claim 4, wherein post-execution metadata is compared against escrow confirmation and vendor license.

16. The system of claim 1, wherein metadata logs are compatible with blockchain-based verification systems.

17. A compliance verification method comprising:
timestamp validation, metadata reconciliation, and execution log comparison.

18. The method of claim 4, wherein the audit trail includes a hash of the metadata for integrity verification.

19. The system of claim 1, wherein metadata visibility is segmented by user role and compliance tier.

20. A commercial audit system comprising:
metadata enforcement, escrow linkage, jurisdiction confirmation, and structured timestamping.
